(19) United States
(12) Patent Application Publication
(10) Pub. No.: US 2026/0126675 A1
(43) Pub. Date: May 7, 2026

(54) Optical Transmitter

(71) Applicant: NTT, Inc., Tokyo (JP)

(72) Inventors: Josuke Ozaki, Musashino-shi, Tokyo (JP); Yoshihiro Ogiso, Musashino-shi, Tokyo (JP); Mitsuteru Ishikawa, Musashino-shi, Tokyo (JP)

(21) Appl. No.: 19/117,474

(22) PCT Filed: Oct. 3, 2022
(86) PCT No.: PCT/JP2022/037036

§ 371 Date: Apr. 1, 2025

(51) Int. Cl. G02F 1/01; H04B 10/50

(52) U.S. Cl. CPC G02F 1/0121; H04B 10/50

(57) ABSTRACT

In an optical transmitter in which an optical modulator and a driver IC thereof are integrally packaged, a new configuration for improving temperature dependency of an optical modulation output characteristic and a mounting form adapted to each configuration are disclosed. An optical transmitter includes an optical modulator chip, a driver IC that operates the optical modulator chip, and a Peltier element, in which the driver IC is placed on the Peltier element, and only the driver IC is temperature-controlled.

### TECHNICAL FIELD

The present disclosure relates to an optical transmitter used in optical communication. More particularly, the present disclosure relates to a mounting form of an optical transmitter including a semiconductor optical modulator and a driver IC thereof.

### BACKGROUND ART

In order to respond to a rapid traffic increase of a communication network, digital coherent optical transmission combining a coherent communication method and a digital signal processing technology has been introduced into an optical fiber communication system. Starting from the establishment of a backbone network transmission technology of 100 Gbps per wavelength at the beginning, transmission of 400 to 600 Gbps per wavelength, which is faster, has been put into practical use at present.

In the above-described digital coherent optical transmission, an optical transmission-reception device in which an optical receiver and an optical transmitter are integrated is used. In an optical transmission-reception device of a system having a transmission capacity exceeding 400 Gbps, an analog component such as a high frequency (RF) electric circuit is required to have a wider bandwidth, and for example, in an optical modulator, a modulation bandwidth of 40 GHz or more is necessary. For reduction of high frequency loss and downsizing of a device, which are linked to a wider bandwidth, for example, a form in which an RF driver IC and an optical modulator are mounted in an integrated package on the transmission side has attracted attention. A mounting form of the optical transmitter is also standardized by the Optical Internetworking Forum (OIF) under the name of High-Bandwidth Coherent Driver Modulator (HB-CDM: high-speed driver integrated optical modulator) (Non Patent Literature 1). Also on the reception side of the optical transmission-reception device, a transimpedance amplifier (TIA) and an optical receiver are mounted in an integrated package, and is also referred to as an integrated coherent receiver (ICR).

Turning to materials for optical transmitting and receiving devices, semiconductor-based optical modulators have attracted attention instead of conventional lithium niobate (LN) optical modulators from the viewpoint of miniaturization and cost reduction. For higher-speed modulation operation, a compound semiconductor represented by InP is mainly used. In addition, research and development are concentrated on Si-based optical devices in systems in which more miniaturization and cost reduction are regarded as important.

There are advantages and disadvantages inherent to the materials also in the above-described semiconductor optical modulator, and for example, in an InP optical modulator, temperature control of an optical modulator chip is essential during operation in order to control a band edge absorption effect. On the other hand, an optical modulator made by LiNbO₃ (hereinafter, “LN optical modulator”) and an optical modulator made by Si (hereinafter, “Si optical modulator”) have an advantage that temperature control is unnecessary, and are considered to be advantageous for low power consumption.

In the case of the HB-CDM using the InP optical modulator, the operation temperature (case temperature) of the optical transmitter is required to be in a range of at least −5° C. to 75° C. In order to ensure such an operation temperature, generally, only an optical modulator chip is mounted on a Peltier element in consideration of power consumption (Patent Literature 1).

However, in the optical transmitter of the related art, deterioration of high frequency characteristics of the driver IC at high temperature has been a problem. Specifically, in a case where the environmental temperature is in a high temperature state, there has been a problem that the high frequency band, the peaking amount, and the gain of the driver IC are deteriorated. As optical transmitters have increased in speed and bandwidth, the influence of deterioration in signal quality due to the above-described deterioration cannot be ignored. Thus, an optical transmitter capable of maintaining a constant high frequency characteristic regardless of a change in environmental temperature is desired.

### CITATION LIST

### Patent Literature

Patent Literature 1: WO 2021/171599 A1

### Non Patent Literature

Non Patent Literature 1: OIF, Implementation Agreement for the High Bandwidth Coherent Driver Modulator (HB-CDM), [online], July 15,2021, [Searched on Sep. 1, 2022], the Internet <URL: https: //www.oiforum.com/wp-content/uploads/OIF-HB-CDM-02.0.pdf>
Non Patent Literature 2: J. Ozaki et al., “500-Gb/s/λ Operation of Ultra-Low Power and Low-Temperature-Dependence InP-Based High-Bandwidth Coherent Driver Modulator,” in Journal of Lightwave Technology, vol. 38, no. 18, pp. 5086-5091, 15 Sep. 15, 2020, doi: 10.1109/JLT.2020.2998466.

### SUMMARY OF INVENTION

In view of the above-described problems, the present disclosure provides a novel configuration and mounting form of an optical transmitter that can suppress temperature dependency of an optical transmitter including a driver IC, has excellent speed, and can stably operate regardless of environmental temperature.

### Solution to Problem

In order to solve the above problem, the present disclosure provides an optical transmitter including an optical modulator chip, a driver IC that operates the optical modulator chip, and a Peltier element, in which the driver IC is placed on the Peltier element, and only the driver IC is temperature-controlled.

### BRIEF DESCRIPTION OF DRAWINGS

FIG. 1 is a side cross-sectional view illustrating a mounting form of an optical transmitter based on HB-CDM of the related art.

FIG. 2 is a side cross-sectional view illustrating the first mounting form of the optical transmitter based on the HB-CDM.

FIG. 3 is a side cross-sectional view illustrating the second mounting form of the optical transmitter based on the HB-CDM.

FIG. 4 is a side cross-sectional view illustrating the third mounting form of the optical transmitter based on the HB-CDM.

FIG. 5 is a side cross-sectional view illustrating the fourth mounting form of the optical transmitter based on the HB-CDM.

FIG. 6 is a top view illustrating a modification of the fourth mounting form of the optical transmitter based on the HB-CDM.

FIG. 7 is a side cross-sectional view illustrating another example of the fourth mounting form of the optical transmitter based on the HB-CDM.

### DESCRIPTION OF EMBODIMENTS

Hereinafter, various embodiments of the present disclosure will be described in detail with reference to the drawings. The same or similar reference signs denote the same or similar components, and redundant description will be omitted in some cases. The materials and numerical values are for illustrative purposes and are not intended to limit the scope of the disclosure. The following description is an example, and some configurations may be omitted, modified, or implemented together with additional configurations without departing from the gist of an embodiment of the present disclosure.

The present disclosure presents a new configuration for improving temperature dependency of a high frequency characteristic of an optical transmitter in an optical transmitter in which an optical modulator and a driver IC thereof are integrally packaged, and a mounting form adapted to each configuration. The configuration for improving the temperature dependency includes a new application form of a temperature regulator (thermoelectric cooler (TEC)) in the optical transmitter. In addition, various mounting forms of driver ICs, optical modulator chips, and spatial optical components adapted to new applications of TECs are also proposed.

The TEC is also called a thermoelectric cooler, and is known as a small cooling device by Peltier junction. The TEC is constituted by an n-type semiconductor, a p-type semiconductor, and a metal, and when a direct current flows through both surfaces of an element formed in a plate shape, heat absorption occurs on one surface and heat dissipation occurs on the other surface. When the direction of the current is reversed, heat absorption and heat dissipation are switched, so that local and accurate temperature control of the IC and the electronic component is possible. In the following description, the temperature regulator is referred to as a TEC for simplicity, and will be described as a Peltier element. As long as the temperature of the driver IC or the optical modulator chip can be controlled, the present invention is not limited to the Peltier element.

In the following, the problem of the temperature dependency of the high frequency characteristics in the optical transmitter will be first described by using an optical modulator in the form of the HB-CDM of the related art as an example. Thereafter, a novel configuration for improving the temperature dependency of the high frequency characteristics by the optical transmitter of the present invention will be described together with various mounting forms.

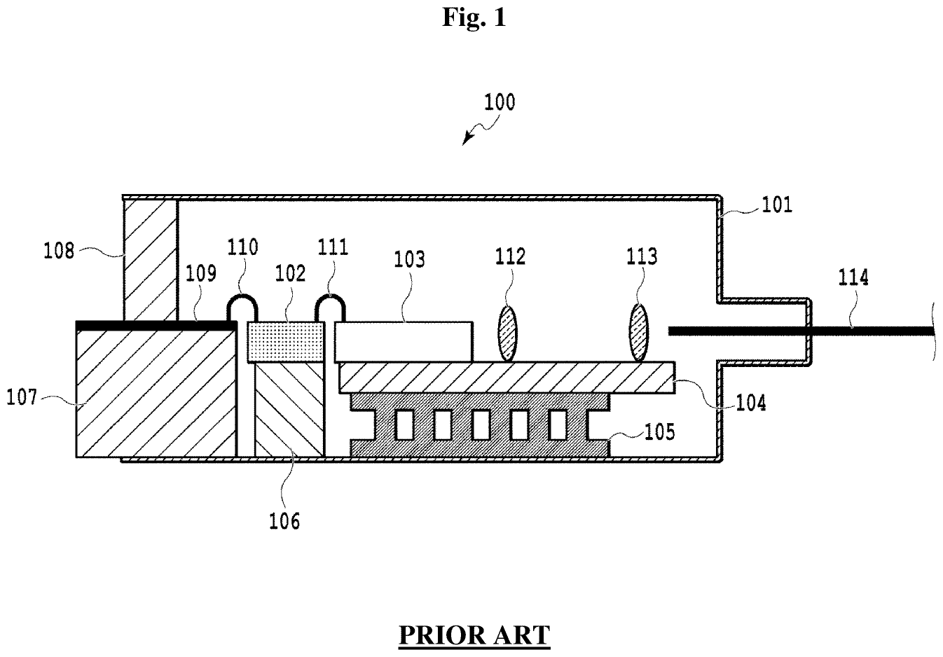

FIG. 1 is a side cross-sectional view illustrating a mounting form of an optical transmitter 100 based on the HB-CDM of the related art. In an optical transmitter 100, a driver IC 102, an optical modulator chip 103, lenses 112 and 113 which are spatial optical components, and the like are housed inside a package housing 101 made by ceramic, metal, or the like, or a combination thereof, according to the specification of the HB-CDM. More specifically, the optical modulator chip 103 is mounted on a bottom surface inside the housing 101 via the subcarrier 104 on the Peltier element 105. At the right end of the optical modulator chip 103 in the drawing, there is an emission end surface of modulated light, and lenses 112 and 113 for optically coupling the modulated light with the optical fiber 114 are also mounted on the subcarrier.

The driver IC 102 is mounted on the metal block or a ceramic material 106 adjacent to the optical modulator chip 103. Further, a wiring board base 107 and a package wall surface 108 are provided as wall surfaces on the left side in the drawing of the package housing 101, and partition the outside and an internal space of the optical transmitter together with the package housing 101. The optical transmitter 100 can be configured in such a manner that the entire package ensures airtightness.

A modulated electrical signal supplied from an external digital signal processor (DSP) is supplied to the optical modulator chip 103 via the wiring layer 109 of the wiring board base 107 and the driver IC 102. The wiring layer 109 and the driver IC 102, and the driver IC 102 and the optical modulator chip 103 are connected by gold wire lines 110 and 111, respectively. In the case of the polarization multiplexing type IQ optical modulation method, the modulated electrical signal includes an I channel and a Q channel for each of the X polarized wave and the Y polarized wave. When one channel is supplied as an electrical signal in a differential signal form, at least eight signal wirings and a GND wiring are necessary for one optical modulator, but the modulation signal form is not limited thereto. As described in Patent Literature 1, the optical transmitter 100 illustrated in FIG. 1 is mounted on a common device substrate together with an ICR package or a DSP in which a TIA and an optical receiver on the reception side are integrated, and can constitute an optical transmission-reception device.

Here, attention is again focused on the Peltier element 105 in the optical transmitter 100. Temperature control is essential in the optical modulator chip 103 manufactured on the InP substrate, and the temperature is controlled to a predetermined operation temperature by the Peltier element 105. As illustrated in FIG. 1, the Peltier element 105 has a size that covers at least the entire region of the optical modulator chip 103, and its position may overlap a region of a spatial optical component such as a lens. On the other hand, in the optical transmitter 100 of the related art, it is considered that the temperature control of the driver IC 102 is not necessary, and the optical transmitter is fixed in the package by the member 106 such as a metal block or ceramic. When the external temperature (environmental temperature) of the optical transmitter 100 rises, the operation temperature of the driver IC 102 also rises. In practice, since the driver IC is also a heating element, in consideration of heat generation from the driver IC, it is estimated that the operation temperature of the driver IC is higher than the external temperature by about +5 to 10° C. When the maximum environmental temperature at which the optical transmission-reception device including the optical transmitter is used is 85° C., the temperature of the driver IC 102 itself is at least 85° C. or higher. The driver IC also has large power consumption, and the driver IC itself generates heat. Therefore, this means that the back side temperature of the driver IC exceeds the maximum environmental temperature of 85° C. due to the influence of heat generation of the driver IC.

The driver IC has temperature dependency on an amplification characteristic (high frequency characteristic) of a high frequency electrical signal, and in a high temperature state, a high frequency band tends to be lower than that in a room temperature state. Conversely, in the low temperature state, the high frequency band tends to increase as compared with the room temperature state. As described above, the high frequency characteristics of the driver IC are different between the low temperature state and the high temperature state. A modulation signal supplied to the driver IC is variously optimized and compensated by the DSP in a room temperature state. However, performing such compensation while dynamically updating with temperature variation is a complicated process and is not generally performed. Since the operation is continued in a constant compensation state at room temperature, the compensation state of the modulation signal deviates from an optimum point when the state changes to the low temperature state or the high temperature state. Thus, optical transmission characteristics and waveform quality of the optical transmitter fluctuate or deteriorate.

The IQ modulator of the optical modulator chip 103 is a linear modulator that preserves the amplitude and phase of the electrical signal, and variations in the level and waveform quality of the modulated electrical signal directly affect the quality of the modulated output light. When the external temperature changes during the operation of the optical transmitter, the operation temperature of the driver IC changes although the optical modulator chip itself is maintained at a constant temperature because the temperature is managed by the Peltier element. As a result, a level variation and a quality variation of the modulated light of the HB-CDM occur, and a transmission characteristic is deteriorated and a problem that the transmission characteristic is not stable also occurs due to a temporal change in the environmental temperature.

The characteristic deterioration caused by the environmental temperature on the high-frequency band of the electrical signal causes waveform distortion of the modulation signal, and the modulation accuracy of the modulated output light from the optical modulator is deteriorated. In an optical receiver that receives such deteriorated modulated light, a BER characteristic has a floor, which leads to deterioration of a transmission characteristic of a system.

The demand for widening the bandwidth of the modulated electrical signal has progressed, and a very wide modulation bandwidth such as 100 GHz or more has started to be required. In such an extremely broadband modulator, the influence of deterioration of high frequency characteristics of the driver IC at high temperatures as described above cannot be ignored. The present disclosure presents a new configuration and mounting form that improve temperature dependency in high frequency characteristics and optical transmission characteristics in an optical transmitter in which an optical modulator and a driver IC thereof are integrally packaged.

An optical transmitter according to an embodiment of the present disclosure will be described in detail below with reference to the drawings. It should be noted that, in the following description, the optical transmitter according to the present disclosure is described as a form of a HB-CDM of a flexible printed circuit board (FPC) interface. However, this is for the purpose of illustration, and an optical transmission module in which a driver IC and an optical modulator chip are integrated has a similar effect.

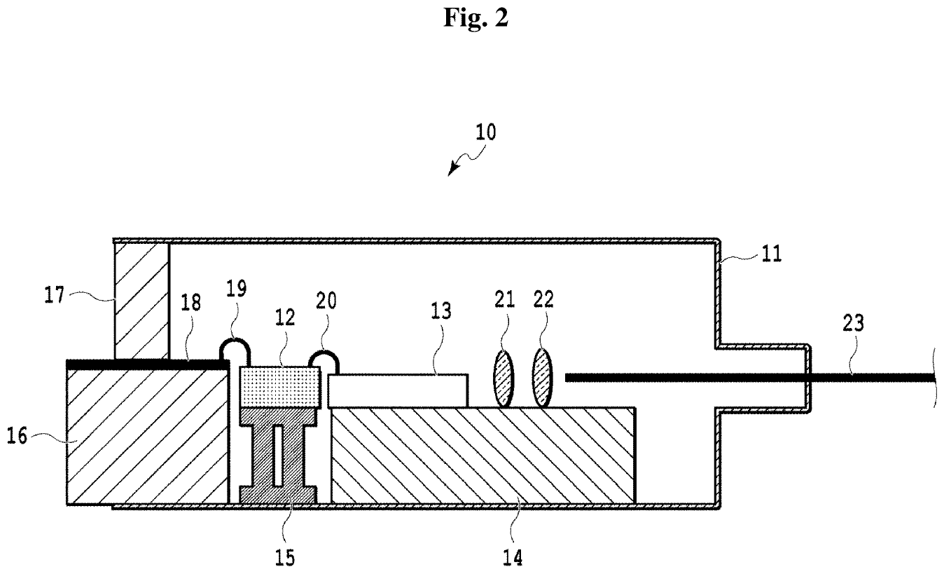

FIG. 2 illustrates a side cross-sectional view of the first mounting form of an optical transmitter based on the HB-CDM of the present disclosure. In the optical transmitter 10 in the first mounting form, similarly to the related art configuration illustrated in FIG. 1, an optical modulator chip 13, a driver IC 12 thereof, and the like are integrally configured inside a package housing 11 along the HB-CDM.

As illustrated in FIG. 2, in the optical transmitter 10, the driver IC 12, the optical modulator chip 13, an optical member (in FIG. 2, lenses 21 and 22, which are spatial optical components, are depicted as an example), and the like are housed inside the package housing 11. More specifically, on the bottom surface of the housing 11, the optical modulator chip 13 is mounted on a carrier 14 including a metal block or a dielectric substrate in a face-up form, and a driver IC 12 is mounted on a Peltier element 15 in a face-up form. At the right end of the optical modulator chip 13 in the drawing, there is an emission end surface of the modulated light, and the lenses 21 and 22 for optically coupling the modulated light with the optical fiber 23 are also mounted on the carrier 14.

Furthermore, the optical transmitter 10 includes a wiring board base 16 and a package wall surface 17 as left wall surfaces of the package housing 11 in the drawing, and partitions the outside and an internal space of the optical transmitter together with the package housing 11. Furthermore, the wiring board base 16 includes an RF terrace (package terrace), and a wiring layer 18 formed on the upper surface of the RF terrace is connected to a flexible substrate (FPC) as a high frequency interface. Note that, although the entire package of the optical transmitter 10 can be configured to ensure airtightness, airtightness is not necessarily essential in the present mounting form using an LN optical modulator or a Si optical modulator unlike the InP optical modulator.

A modulated electrical signal supplied from an external digital signal processor (DSP) is supplied to the optical modulator chip 13 via the wiring layer 18 of the wiring board base 16 and the driver IC 12. The wiring layer 18 and the driver IC 12 are connected by a wire line 19. Further, the driver IC 12 and the optical modulator chip 13 are also connected by a wire line 20. As the wire lines 19 and 20, for example, a bonding wire such as a gold wire line can be used.

A difference between the optical transmitter 10 of the first mounting form and the optical transmitter 100 of the related art in FIG. 1 is that the optical modulator is not InP, and an LN optical modulator or a Si optical modulator that does not need temperature control and is made by LiNbO₃ or Si is used. In addition, as illustrated in FIG. 2, since temperature control of the optical modulator is unnecessary in the first mounting form, the optical transmitter 10 does not include a Peltier element that controls the optical modulator. In this mounting form, the optical modulator is mounted on the carrier 14 and not on the Peltier element. That is, in this mounting form, only the driver IC 12 is mounted on the Peltier element 15, and the temperature of the driver IC 12 can be controlled.

At this time, in order to improve heat dissipation by the Peltier element 15, the driver IC 12 needs to be mounted on the Peltier element with a conductive paste or solder having a thermal conductivity of 30 W/mK or more and excellent thermal conductivity.

In this first mounting form, the carrier 14 serves as a foundation for fixing and holding the optical modulator chip 13 and the spatial optical component. In addition, in a case where wiring for taking out DC wiring of the optical modulator chip is necessary on the carrier 14, it is sufficient if the carrier 14 is constituted by a dielectric substrate, or the carrier 14 is constituted by a metal block, and a dielectric substrate for forming wiring is provided on at least a part of the upper surface thereof.

In FIG. 2, the carrier 14 is depicted as being constituted by one layer since it may be a metal block, but may be a multilayer when the carrier 14 is constituted by a dielectric substrate. By using the multilayer, when the number of DC wirings to the optical modulator is large, or when it is necessary to perform cross wiring for switching the order of terminals, it is possible to perform a flexible element/wiring layout using multilayer wiring. In addition, in a case where the dielectric substrate is used, a positioning marker or the like for mounting the spatial optical component can be formed by a metal pattern.

Here, a mounting structure that contributes to improvement of the high frequency characteristics of the driver IC and the quality of modulated high output of the optical modulator will be described.

In the first mounting form, as illustrated in FIG. 2, it is assumed that the driver IC 12 and the optical modulator chip 13, and the driver IC 12 and the wiring layer 18 formed on the upper surface of the RF terrace included in the wiring board base 16 are connected using, for example, the wire lines 19 and 20 which are bonding wires. As described above, in a case where the elements are connected by wire lines, when lengths of the wire lines increase, inductance increases, and thus the roll-off frequency shifts to the low frequency side due to the high frequency characteristic by LC resonance. Therefore, from the viewpoint of high frequency characteristics, it is desirable that the inductance of the wire lines is low.

Thus, in the first mounting form, the height direction and the planar direction are defined. In the first mounting form, as illustrated in FIG. 2, nothing is sandwiched between the driver IC 12 and the Peltier element 15, and the driver IC 12 is mounted immediately above the Peltier element 15. On the other hand, the optical modulator chip 13 and the lenses 21 and 22 are mounted on the carrier 14, and the difference in height between the driver IC 12 and the modulator chip 13 is adjusted by adjusting the thickness of the carrier 14. Similarly, the difference in height between the driver IC 12 and the RF terrace can be set to a desired difference by adjusting the height of the wiring board base 16.

Specifically, thicknesses of respective members are adjusted in such a manner that each of differences in height between the electrode pad of the driver IC 12 and the electrode pad of the optical modulator chip 13 and between the electrode pad of the driver IC 12 and the electrode pad of the RF terrace is equal to or less than 100 μm. This value is indicated as an example of a range that can be achieved practically in consideration of variations in mounting and variations in the thicknesses of the optical modulator chip 13 and the driver IC 12, and the heights of the electrode pads on the upper surfaces of the driver IC 12 and the optical modulator chip 13 can be made uniform by adjusting the thicknesses of the respective members.

However, from the viewpoint of shortening the length of the wire line, in the case of connection by a bonding wire using a ball wire or the like, it is best to mount the wire line in such a manner that the height on the optical modulator chip 13 side is slightly lower than that of the driver IC 12 and the wire line is drawn up from the optical modulator chip 13 side to the driver IC 12 side. Similarly, regarding the driver IC 12 and the RF terrace, the height of the driver IC 12 is desirably slightly lower than that of the RF terrace. In addition, in the case of connection using a flat wire such as a ribbon wire, it is desirable that the height on the optical modulator chip 13 side, the height of the driver IC 12, and the height of the driver IC and the RF terrace are aligned.

Since the gap in the planar direction between the optical modulator chip 13 and the driver IC 12 is directly connected to the length of the wire line, the gap between the optical modulator chip 13 and the driver IC 12 is desirably as small as possible. Considering the accuracy in the mounting process and the risk of short circuit, this gap is desirably controlled to, for example, 50 μm or less. Further, even if the gap between the optical modulator chip and the driver IC is controlled, when each electrode pad is formed at a position away from the chip end, there is no effect of shortening the length of the wire line, and thus the electrode pad is formed at a position of 50 μm or less from each chip end. When the distance from the chip end to the electrode pad is 50 μm or less, it can be achieved by normal dicing or cleavage.

In this way, by setting the gap in the planar direction as small as possible, it is possible to connect elements with a small wire inductance while having mountability. In addition, it is possible to further reduce the inductance by using a plurality of ball wires, a wide ribbon wire, or the like at least between the signal electrode pads.

As described above, the driver IC is a heating element, and is not considered as an object to be temperature-controlled by the Peltier element. Driving power is required to operate the Peltier element, and it is not considered to use extra power for the heating element. However, in order to achieve a broadband of an optical transmitter, the inventors have reached a new idea of adding temperature control to the driver IC which is a heating element.

As described above, the optical transmitter 10 according to the first mounting form includes the optical modulator that does not need temperature control, such as an LN optical modulator or a Si optical modulator, and the driver IC, and an optical modulator chip that does not need temperature control is mounted on the carrier 14 constituted by a metal block or a dielectric substrate, and only the driver IC is mounted on a Peltier element, thereby enabling temperature control of the driver IC that needs temperature control and achieving power saving.

In addition, in the optical transmitter of the present mounting form, temperature control is unnecessary for the optical modulator itself and there is almost no temperature dependency, and thus it is not necessary to consider the influence of heat inflow from the Peltier element or the driver IC or thermal separation thereof. Furthermore, since the optical transmitter of the present mounting form does not need the TEC of the optical modulator and only the driver IC is mounted on the TEC, the total power consumption is not significantly degraded even as compared with the conventional optical transmitter in which only the InP optical modulator is mounted on the TEC.

For the driver IC 12, it is known that the high frequency characteristics are better in the low temperature state than in the high temperature state, and from this viewpoint, the set temperature of the Peltier element 15 that controls the temperature of the driver IC 12 is preferably lower. However, when the set temperature is too low, improvement of the high frequency characteristics of the driver IC is limited as compared with the magnitude of the power consumption of the Peltier element. Therefore, considering that the operating environmental temperature of the optical transmitter 10 changes in the range of about −5° C. to 85° C., it is most appropriate to control the Peltier element to a constant temperature in the range of 25° C. to 50° C. from the viewpoint of achieving both power consumption and high frequency characteristics. As described above, by mounting the driver IC on the Peltier element and controlling the temperature of the Peltier element to a constant temperature, it is possible to achieve an optical transmitter in which the high frequency characteristics are not deteriorated even when the outside air temperature is high, and the high frequency characteristics are not changed even when the outside air temperature changes. However, if power consumption is not a concern in giving priority to characteristics, it is effective to set a temperature lower than 25° C. for use in order to ensure characteristics.

As described above, the optical transmitter 10 of the present mounting form can be implemented as the optical transmitter including the optical modulator 13, the driver IC that operates the optical modulator, and the Peltier element 15, in which the driver IC is placed on the Peltier element, and only the driver IC is temperature-controlled.

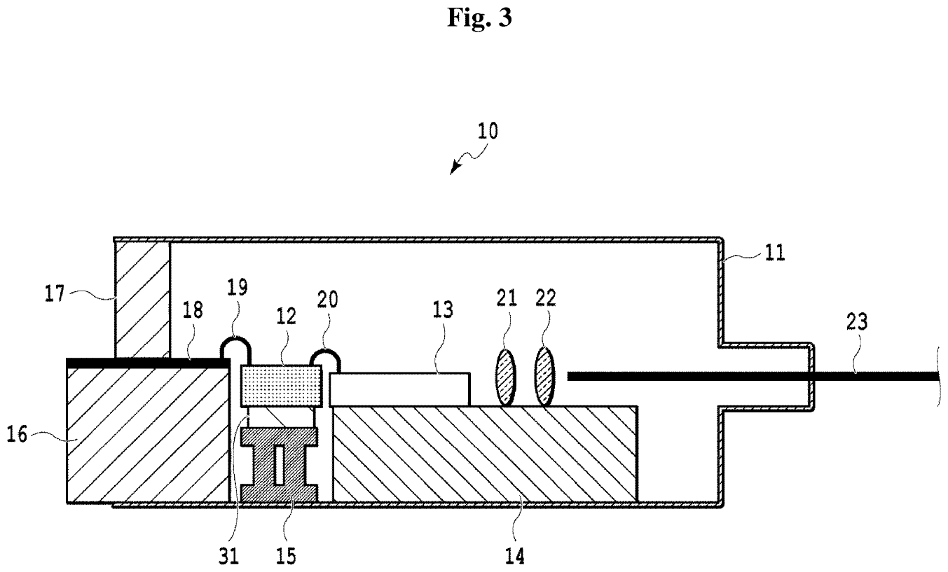

Next, the second mounting form will be described with reference to FIG. 3.

FIG. 3 illustrates a side cross-sectional view of the second mounting form of an optical transmitter based on the HB-CDM of the present disclosure. In the optical transmitter 10 of the second mounting form illustrated in FIG. 3, similarly to the configuration illustrated in FIG. 2, the optical modulator chip 13, the driver IC 12 thereof, and the like are integrally configured inside the package housing 11 along the HB-CDM. The wiring board base 16 and the package wall surface 17 are provided as the wall surface on the left side in the drawing of the package housing 11, and the inside and the outside of the package are similarly partitioned.

The difference between the second mounting form of FIG. 3 and the first mounting form of FIG. 2 is that the driver IC 12 is mounted on the Peltier element 15 via a subcarrier 31 including a metal block or a dielectric substrate. Also with respect to the driver IC 12, in a case where the DC wiring is necessary, similarly to the carrier 14 on which the optical modulator chip 13 is mounted, it is sufficient if the subcarrier 31 is constituted by a dielectric substrate, or the subcarrier 31 is constituted by a metal block, and a dielectric substrate for forming wiring is provided on at least a part of the upper surface thereof. At this time, from the viewpoint of controlling the temperature of the driver IC 12 by the Peltier element 15, the subcarrier 31 is desirably made by a material having excellent thermal conductivity, such as aluminum nitride (AIN). Even when the subcarrier is formed by a dielectric substrate, it is desirable to use an AIN substrate capable of multilayer wiring. Furthermore, by adjusting the thickness of the subcarrier 31, the height can be adjusted between the driver IC 12 and the optical modulator chip 13 and between the driver IC 12 and the RF terrace.

Furthermore, in a case where the number of wirings of the driver IC 12 is large and complicated, similarly to the optical modulator chip described above, a multilayer AIN substrate can be used as the subcarrier 31.

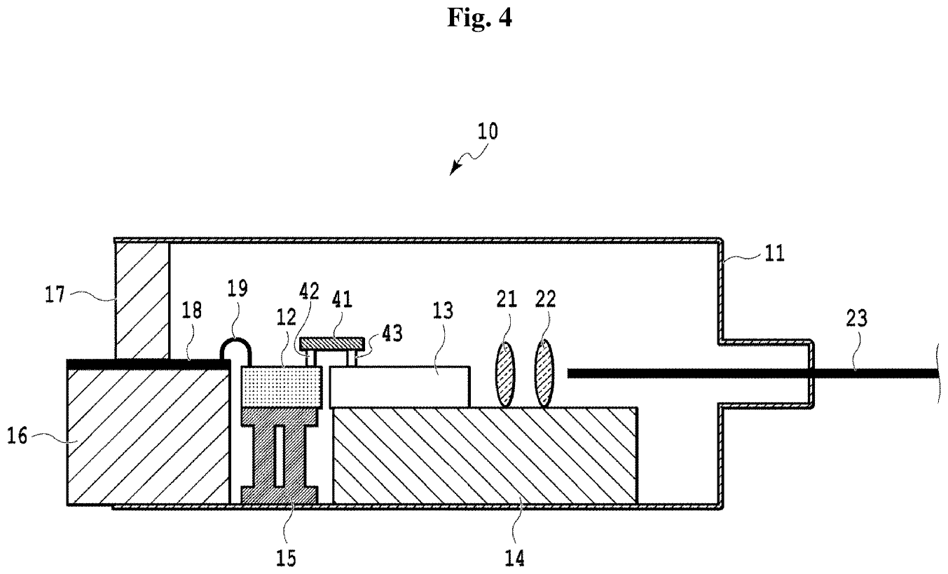

Next, the third mounting form will be described with reference to FIG. 4.

FIG. 4 illustrates a side cross-sectional view of the third mounting form of an optical transmitter based on the HB-CDM of the present disclosure. In the optical transmitter 10 of the third mounting form illustrated in FIG. 4, similarly to the configuration illustrated in FIGS. 2 and 3, the optical modulator chip 13, the driver IC 12 thereof, and the like are integrally configured inside the package housing 11 along the HB-CDM. The wiring board base 16 and the package wall surface 17 are provided as the wall surface on the left side in the drawing of the package housing 11, and the inside and the outside of the package are similarly partitioned. In each of the mounting forms illustrated in FIGS. 2 and 3, the driver IC 12 and the optical modulator chip 13 are both wire-connected, but in the optical transmitter of the third mounting form, the driver IC 12 and the optical modulator chip 13 are connected by the wiring board 41 instead of the wire connection. As illustrated in FIG. 4, in the third mounting form, the driver IC 12 is mounted on the Peltier element 15 in a face up form, and the optical modulator chip 13 is mounted on the carrier 14 in a face-up form. Then, the driver IC 12 and the optical modulator chip 13 are connected by flip-chip mounting the wiring board 41 face down.

As described above, in the third mounting form, the driver IC 12 and the optical modulator chip 13 are connected by flip-chip mounting the wiring board 41 face down. At this time, when there is a certain level or more difference in height between the driver IC 12 and the optical modulator chip 13, the wiring board cannot be mounted well. Therefore, in the third mounting form, the height difference between the driver IC 12 and the optical modulator chip 13 is set to be as small as possible. As the Au bump/pillar or the Cu bump/pillar used for flip-chip mounting, those having a diameter and a height of 100 μm or less are generally used in many cases. Therefore, the height difference between the driver IC 12 and the optical modulator chip 13 is desirably controlled to be equal to or less than at least 100 μm, and desirably equal to or less than 50 μm.

In addition, in a case where the wiring board 41 is flip-lip mounted, when the inclination in the height direction of the main surface of the wiring board 41 with respect to the main surface of the driver IC 12 or the optical modulator chip 13 exceeds ±3°, a bonding failure such as generation of a gap in the joint portion may occur. In addition, since a stress concentration portion may be generated in the joint portion accordingly, there is a possibility that the joint portion is brittle against vibration impact and causes destruction of the joint portion, and as a result, long-term reliability of the device cannot be ensured. Therefore, when the wiring board 31 is mounted, it is quite important to perform management so as not to incline at the time of mounting each member in such a manner that the inclination in the height direction of the wiring board 31 on the main surface of the driver IC or the optical modulator chip is within +3°, to perform height adjustment of each member in such a manner that the heights of the driver IC and the optical modulator chip coincide with each other, and to perform tolerance management. When there is a difference in height between the surfaces of the driver IC 12 and the optical modulator chip 13, such as when the thicknesses of the driver IC and the optical modulator chip are different, the heights of the driver IC and the optical modulator chip can be adjusted by adjusting the thickness of the carrier 14.

In order to simplify the description, FIG. 4 illustrates an example in which the thicknesses of the Peltier element 15 and the dielectric substrate 14 are the same, and the thicknesses of the driver IC 12 and the optical modulator chip 13 are also the same, so that the heights of the surface of the driver IC 12 and the surface of the optical modulator chip 13 are adjusted to coincide with each other. In this example, since the height of the surface of the driver IC 12 and the height of the surface of the optical modulator chip 13 are aligned, by flip-chip mounting and connecting the wiring board 41 as illustrated in FIG. 4, it is possible to perform connection using Au bumps/pillars or Cu bumps/pillars 42 and 43. Since the third mounting form is a mounting form in which the wire line is not used for connecting the driver IC 12 and the optical modulator chip 13, the inductance can be greatly reduced as compared with the first mounting form and the second mounting form.

As described above, in the third mounting form, since the inductance is reduced by connecting the driver IC and the optical modulator chip using the wiring board, the distance between the driver IC and the optical modulator chip can be freely set, but in consideration of the size of the pillar/bump at the time of mounting and the mounting accuracy, it is desirable to separate the driver IC and the optical modulator chip from each other by 300 μm or more. In addition, from the viewpoint of strength at the time of bonding and from the viewpoint of deterioration of high frequency characteristics, it is desirable that the length of the wiring board be kept within 2 mm or less at the longest, and it is more advantageous from the viewpoint of high frequency as the value of the dielectric constant or the dielectric loss tangent is smaller. Therefore, in the third mounting form, the distance between the driver IC and the optical modulator chip is desirably in the range of 300 μm to 2 mm.

Although not described here, the AIN substrate may be mounted between the driver IC and the Peltier element as in the second mounting form of FIG. 3. For other configurations and concepts that are the same as those in the second mounting form of FIG. 3, this description overlaps and hence is omitted. However, in order to strictly manage the height tolerance and the parallelism, it is desirable that the number of members is small, and thus, in the third mounting form, it can be said that it is the most desirable configuration to directly mount the driver IC on the TEC such as the Peltier element.

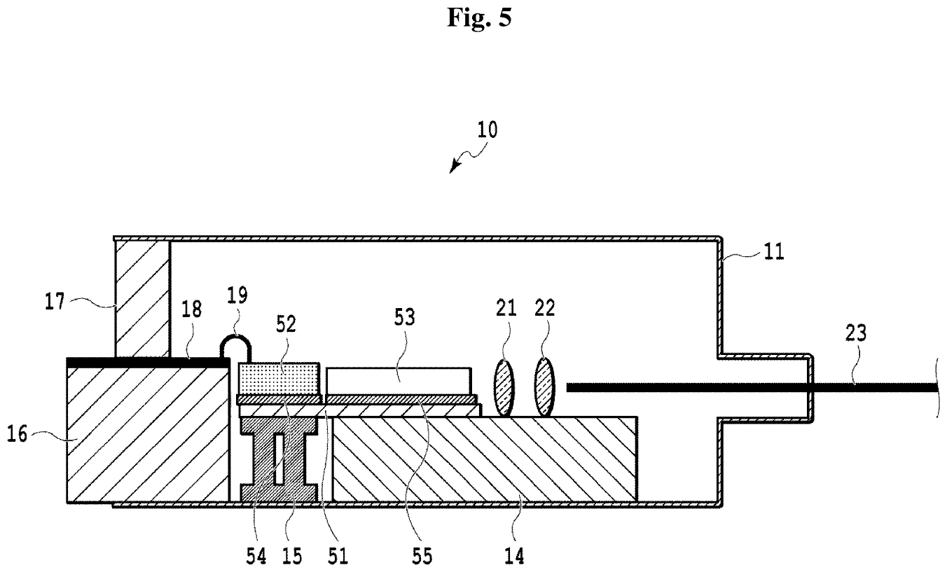

Finally, the fourth mounting form will be described with reference to FIGS. 5 to 7.

FIG. 5 illustrates a side cross-sectional view of the fourth mounting form of an optical transmitter based on the HB-CDM of the present disclosure.

The optical transmitter 10 of the fourth mounting form illustrated in FIG. 5 is obtained by flip-chip mounting a driver IC 52 and an optical modulator chip 53 in a face-down form. The face down means that the pad surfaces of the driver IC 52 and the optical modulator chip 53 are mounted so as to face downward in the drawing. Also in the fourth mounting form illustrated in FIG. 5, similarly to each mounting form described above, the optical modulator chip 53, the driver IC 52 thereof, and the like are integrally formed inside the package housing 11 along the HB-CDM. The wiring board base 16 and the package wall surface 17 are provided as the wall surface on the left side in the drawing of the package housing 11, and the inside and the outside of the package are similarly partitioned. In the embodiment illustrated in FIG. 5, both the driver IC 12 and the optical modulator chip 13 are flip-chip mounted on the subcarrier 51 face down using Au pillars/bumps, Cu pillars/bumps, or the like.

When the driver IC 52 or the optical modulator chip 53 is flip-chip mounted, it is quite important to manage the flatness of the outermost surface of the subcarrier 51 on which each member is mounted in order to prevent the member to be mounted from being inclined. For example, the flatness of the uppermost surface of the subcarrier 51 on which each member is mounted is desirably 0.05 mm or less. In addition, since the temperature of the driver IC 52 flip-chip mounted face down is controlled by the Peltier element 15, it is desirable that the underfill material 54 having excellent thermal conductivity is embedded in the gap between the driver IC 52 and the dielectric substrate 51. As the underfill material having excellent thermal conductivity, for example, an underfill material having a thermal conductivity of 3 W/mK or more is desirable.

On the other hand, since the optical modulator chip 53 of the fourth mounting form is an LN optical modulator or a Si optical modulator that does not need temperature control similarly to the above mounting forms, it is not always necessary to embed the underfill material 55 having high thermal conductivity between the optical modulator chip 53 and the subcarrier 51. However, embedding the underfill material 55 between each element mounted on the subcarrier and the dielectric substrate is quite effective in ensuring connection strength. Therefore, the underfill material may be the same as or different from the underfill material used between the driver IC and the subcarrier, but it is desirable to use the underfill material also in the gap between the optical modulator chip and the subcarrier.

As described above, in the fourth mounting form, the flip-chip mounting is used for the connection between the driver IC and the optical modulator, and the inductance of the electrical signal path is suppressed to about ⅕ to 1/10 as compared with the normal wire connection, and the bandwidth can be widened. Then, from the viewpoint of high frequency characteristics, if the wiring becomes too long, the loss increases and the high frequency characteristics deteriorate, and thus it can be said that the distance between the driver IC and the optical modulator chip is preferably as short as possible. However, the distance between the driver IC and the optical modulator chip is appropriately 300 μm or more from the viewpoint of ease of access of a jig or the like at the time of mounting. However, considering the high frequency characteristics, an excessively long distance between the driver IC and the optical modulator chip leads only to characteristic deterioration, and thus it is necessary to suppress the distance between the driver IC and the optical modulator chip to 2 mm or less at the maximum.

The subcarrier 51 of the fourth mounting form is constituted by a dielectric substrate, and wiring for extracting a DC wiring of the driver IC 52 and the optical modulator chip 53, an RF line for RF connection between the driver IC 52 and the optical modulator chip 53, and the like are formed thereon by a metal pattern.

In FIG. 5, although the subcarrier 51 is depicted as one layer for the sake of simplicity, as described above, since a plurality of DC wirings and RF lines are routed on the subcarrier, it is desirable to configure the subcarrier 51 with multiple layers and to properly layout the subcarrier so that the wirings do not interfere with each other.

In addition, the temperature control of the driver IC 52 by the Peltier element 15 is performed via the subcarrier 51. In addition, the amount of heat generated by the driver IC 52 is large. Thus, it is desirable to use a material having as excellent thermal conductivity as possible as the subcarrier 51. Furthermore, since a high frequency line is also formed, it is desirable that the dielectric constant and the dielectric loss tangent have smaller values. As described above, a ceramic substrate such as an AIN substrate is suitable as a subcarrier using a material excellent in thermal conductivity. If the subcarrier is configured by the AIN substrate, multilayer wiring can be performed.

The high-frequency wiring for connecting the driver IC 52 and the optical modulator chip 53 in the subcarrier 51 is best formed on the outermost surface of the subcarrier 51 from the viewpoint of high-frequency loss. However, when the high-frequency signal line is formed on the outermost surface, the underfill material may be taken over on the high-frequency signal line. It is difficult to control the degree of protrusion of the underfill material to the periphery of the chip with high accuracy. For this reason, asymmetry of the pair of high frequency signal lines (for example, I+ and I−) formed by the differential lines and variation between channels may occur, and high frequency characteristics and transmission characteristics may be adversely affected.

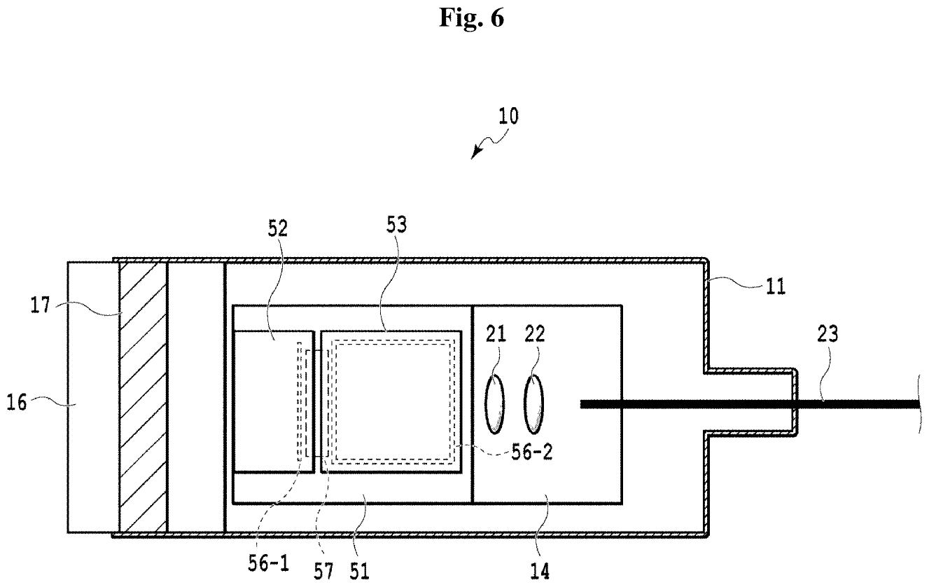

FIG. 6 is a top view illustrating a modification of the fourth mounting form, and corresponds to a top view in which the housing 11 of the optical transmitter 10 illustrated in FIG. 5 is cut and a circuit surface inside the module is viewed. In this modification, in order to prevent the underfill material from flowing into the high frequency signal line of the subcarrier 51, grooves 56-1 and 56-2 are formed in the upper surface of the subcarrier 51 as indicated by dotted lines. The high-frequency wiring of the subcarrier 51 is configured in a dotted line region 57 between the driver IC 52 and the optical modulator chip 53. Electrode pads are formed around the driver IC 52 and the optical modulator chip 53. By forming the grooves in the upper surface of the subcarrier 51 at a position inside these surrounding electrode pads, an excess underfill material during the manufacturing process is accommodated in the grooves. That is, the excess underfill material can be accommodated in the groove without being spread on the high-frequency wiring around the IC and the chip.

FIG. 6 illustrates an example in which the linear groove 56-1 is formed only on one side of the region 57 of the high frequency wiring in the driver IC 52, and the rectangular groove 56-2 is formed near four peripheral sides of the chip in the optical modulator chip 53. The shape of the groove is not limited to the configuration illustrated in FIG. 6, and can be changed according to the property of the underfill material, the form of the wiring on the subcarrier to avoid the influence, and the like. For example, in FIG. 6, the groove 56-1 of the driver IC 52 is provided only on one side on the optical modulator chip side, but may be formed in a rectangular shape around four peripheral sides of the driver IC. Furthermore, in addition to the configuration of FIG. 6, a linear groove may be added to one side of the driver IC on the RF terrace side, that is, on the wiring board base 16 side.

It is desirable to provide a groove for releasing the underfill material also on the subcarrier near the output point of the waveguide of the optical modulator chip 53. Referring to FIG. 5 again, when the underfill material rises in the vicinity of the chip end surface on the lens side of the optical modulator chip 53, the underfill material adheres to the emission end surface, and optical coupling with the lenses 21 and 22 may be deteriorated. The groove of one side on the lens 21 side of the rectangular groove 56-1 of the optical modulator chip 53 illustrated in FIG. 6 is also effective for avoiding such a trouble of optical coupling.

In a case where the subcarrier 51 is formed by a multilayer structure, the influence of the underfill material described above can be avoided by configuring the high frequency line in the inner layer of the dielectric substrate. In addition, if the high-frequency wiring is configured in the inner layer, a groove can be formed in the upper surface of the subcarrier 51 at any position between the optical modulator chip and the driver IC. It goes without saying that sufficient consideration is necessary for disconnection of inner layer wiring, an influence on the characteristic impedance, and the like. On the other hand, when high frequency wiring is designed with the same line impedance due to the influence of the effective dielectric constant of the subcarrier, the signal line width becomes narrow in the inner layer wiring. Furthermore, since the influence of the dielectric loss tangent of the subcarrier is also received, it is desirable that the wiring pattern is present on the outermost surface of the subcarrier 51 when considering only the loss of the high frequency line.

In the arrangement of the spatial optical components in FIG. 6, the lenses 21 and 22 are arranged on the carrier 14 on the opposite side of the optical modulator chip 53 from the driver IC 52. However, for example, the at least one lens can also be arranged on the upper side or the lower side of the chip 53 of the optical modulator when viewed in the top view of FIG. 6. That is, the spatial optical component is mounted above the carrier 14 on a side different from the side facing the driver IC 12 of the chip of the optical modulator. A groove for releasing excess underfill material can be formed in the vicinity of a side of a chip of the optical modulator corresponding to the spatial optical component.

In the fourth mounting form, the optical modulator chip 53 is mounted in a face down form. Thus, the waveguide that emits the modulator output light of the optical modulator chip 53 is at a position close to the subcarrier 51 in the height direction. Depending on the height of the waveguide from the lower surface of the optical modulator chip 53, the height of the Au pillar/bump or the Cu pillar/bump, and the size of the lens, it may be difficult to mount the lens. Thus, in this mounting form, as illustrated in FIG. 5, the subcarrier 51 is mainly provided only below the driver IC and the optical modulator chip, and the spatial optical member is directly mounted on the carrier 14. That is, in this mounting form, the subcarrier 51 does not exist in the portion where the spatial optical member (in FIG. 5, lenses 24 and 25) is mounted, and the height difference between the position of the waveguide and the upper surface of the carrier 14 on which the lens is mounted is provided by the thickness of the subcarrier 51, thereby enabling lens implementation.

Also in this case, when the height adjusting carrier 14 is formed by a dielectric substrate, an alignment mark for optical mounting can be provided thereon.

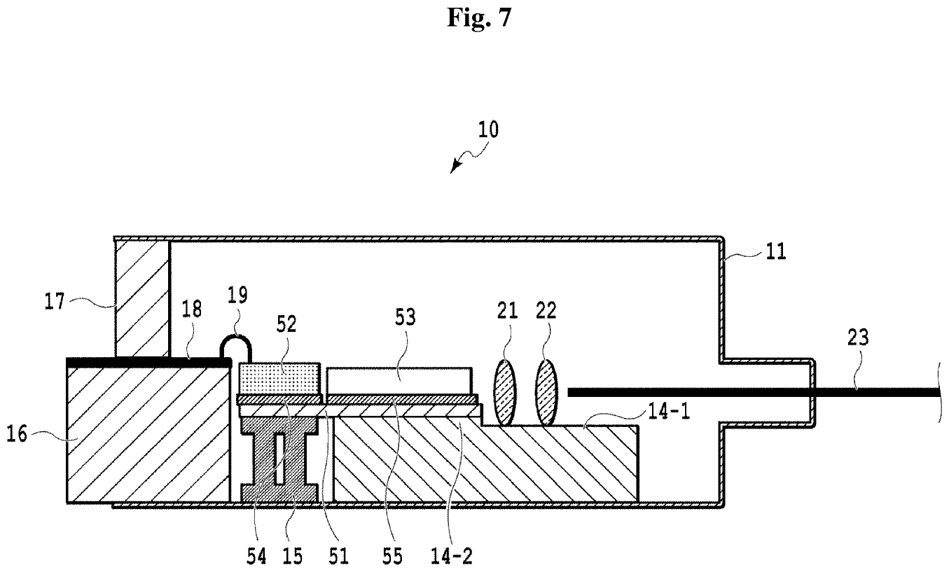

FIG. 7 is a side cross-sectional view illustrating another example of the fourth mounting form illustrated in FIG. 5.

The optical transmitter 10 in FIG. 7 is different from the configuration of the optical transmitter 10 in FIG. 5 in terms of mounting form of the lenses 21 and 22.

The optical transmitter 10 of FIG. 7 can facilitate optical coupling of the lens by changing the thickness of the carrier 14 between the mounting region of the optical modulator chip and the mounting region of the spatial optical component such as the lenses. The carrier portion 14-2 in the region of the optical modulator chip 53 is thinner than the carrier portion 14-1 in the mounting region of the lenses 21 and 22. For the carrier portion 14-1 on which the spatial optical component is mounted, it is desirable that the thickness of the carrier is equal to or larger than the radius of the lens. For example, assuming that the diameter of the lens is 500 μm, the carrier portion 14-1 needs to be lowered by at least 250 μm or more from the upper surface to be thin. By controlling the thicknesses of the underfill materials 54 and 55 to be the same height as the Au pillar and the Cu pillar, it is possible to align the optical axis from the emission point of the light modulation output light to the optical fiber 23. The height of the carrier 14 can also be changed by using the carrier as a multilayer substrate to reduce the number of layers of the subcarrier portion 14-2 in the mounting region of the lenses 21 and 22.

Note that FIG. 5 illustrates an example in which only the driver IC and the optical modulator chip are mounted on the subcarrier 51, and the subcarrier does not exist in the region where the spatial optical member is mounted. However, the subcarrier 51 may be extended to a portion where the spatial optical member is mounted, and the spatial optical member may be mounted on the subcarrier 51. In this case, a step may be formed by slightly cutting the mounting region portion of the spatial optical member of the subcarrier 51.

In addition, in FIGS. 5 and 7, the optical modulator and the optical fiber are optically coupled using the lens as the spatial optical member as an example, but the lens may not be mounted. For example, even in a case where the optical modulator and the optical fiber are directly optically coupled without using a lens, similarly, it is possible to easily achieve optical axis alignment between the light emitted from the optical modulator and the optical fiber according to the shape of the fiber or the like.

Note that, in the first to fourth mounting forms described above, all connections between the driver IC and the RF terrace are assumed to be connections with wire lines. The influence of inductance of the wire lines used for connection between the driver IC and the RF terrace on the high frequency characteristics is smaller than the inductance of the wire line used for the connection between the optical modulator chip and the driver IC. However, even if the influence is small, the influence on the high frequency characteristics occurs, and thus it is desirable to take a countermeasure similarly. For example, in order to reduce the length of the wire line used for connection, it is desirable that the height difference between the driver IC and the RF terrace is also equal to or less than 100 μm, and the gap between the driver IC and the RF terrace in the planar direction is also equal to or less than 100 μm.

Furthermore, in order to further reduce the inductance, the connection between the driver IC and the RF terrace may be a connection by flip-chip mounting using a wiring board and a pillar/bump instead of the wire line. Even in this case, for reasons similar to the height difference between the driver IC 23 and the optical modulator chip 13 of the third mounting form and the inclination of the wiring board 41, the height difference of the upper surface of each of the wiring layers of the driver IC and the RF terrace needs to be equal to or less than at least 100 μm (ideally equal to or less than 50 μm), and the inclination of the surface of the wiring board used for connection with respect to the surface of the wiring layer of the driver IC and the RF terrace needs to be within ±3°. In this case, the materials of the wiring board and the pillars/bumps may be the same as or different from those of the wiring board 41 and the pillars/bumps 42, 43 in the third mounting form, but it is desirable to use the same material from the viewpoint of cost. Furthermore, the input/output PAD of the driver IC is made the same, and the PAD shape, pitch, and the like of the connection portion between the optical modulator chip and the wiring layer are made the same, whereby the cost can be reduced using the same wiring board.

In addition, each of the first to fourth mounting forms includes a configuration in which a lens is mounted as a spatial optical member, but an optical transmitter having a configuration other than a configuration in which a lens is mounted can be similarly mounted. The member to be mounted may be a member for fixing an optical fiber, a polarization beam combiner (PBC), or the like, in addition to the lens. In addition, not limited to the lens mounting, a spatial optical member other than the lens may be mounted, or a spatial optical member may not be mounted.

As described above, according to the present disclosure, it is possible to achieve a novel configuration and mounting form of an optical transmitter that suppresses temperature dependency of the optical transmitter including the driver IC, has excellent speed, and can stably operate regardless of environmental temperature.

### INDUSTRIAL APPLICABILITY

The present invention can be used for an optical communication network.

1. An optical transmitter, comprising:
an optical modulator chip;
a driver IC that operates the optical modulator chip; and
a Peltier element, wherein
the driver IC is placed on the Peltier element, and only the driver IC is temperature-controlled.

2. The optical transmitter according to claim 1, wherein the optical modulator chip and the driver IC are mounted on a carrier and the Peltier element, respectively, in a face-up manner, a pad of the optical modulator chip and a pad of the driver IC are connected by a bonding wire, and a difference in height between upper surfaces of the driver IC and the optical modulator chip is equal to or less than 100 μm.

3. The optical transmitter according to claim 2, wherein the optical modulator chip and the driver IC are arranged in such a manner that a distance between the optical modulator chip and the driver IC is equal to or less than 50 μm, and the pad of the optical modulator chip and the pad of the driver IC are arranged within 50 μm from a chip end.

4. The optical transmitter according to claim 1, wherein the optical modulator chip are mounted on a carrier and the driver IC are mounted on the Peltier element, respectively, in a face-up manner and electrically connected by a wiring board that is flip-chip mounted using a pillar or a bump between the optical modulator chip and the driver IC in a face-down manner, a difference in height between upper surfaces of the driver IC and the optical modulator chip is equal to or less than 100 μm, an inclination in a height direction of a main surface of the wiring board with respect to main surfaces of the optical modulator chip and the driver IC is within ±3°, and a distance between the optical modulator chip and the driver IC is equal to or more than 300 μm and equal to or less than 2 mm.

5. The optical transmitter according to claim 1, wherein
the optical modulator chip and the driver IC are flip-chip mounted face down on a subcarrier using a pillar or a bump, and
the driver IC is mounted on the Peltier element via the subcarrier, the optical modulator chip is mounted on a carrier via the subcarrier, and the driver IC and the optical modulator chip are electrically connected by the subcarrier.

6. The optical transmitter according to claim 5, wherein the subcarrier includes an aluminum nitride (AIN) substrate, flatness of an outermost surface of the subcarrier is 0.05 mm or less, and a distance between the optical modulator chip and the driver IC is 300 μm or more and 2 mm or less.

7. The optical transmitter according to claim 5, wherein
an optical component is mounted on a side different from a side of the optical modulator chip facing the driver IC, an underfill material having a thermal conductivity of 3 W/mK or more is embedded in a gap between the subcarrier and the driver IC, and a space between the subcarrier and the optical modulator chip is embedded with a material that is identical to or different from the underfill material, and
a groove is formed on a surface of the subcarrier near one side of the optical modulator chip on a side of the optical component.

8. The optical transmitter according to claim 5, wherein
an optical component is mounted on the carrier on a side of the optical modulator chip opposite to the driver IC, and a region of the carrier where the optical component is mounted has a thickness smaller than a thickness of a region of the carrier where the optical modulator chip is mounted.

9. The optical transmitter according to claim 1, wherein the Peltier element is controlled to be constant at any temperature in a range of 25° C. to 50° C. regardless of an outside air temperature, and the driver IC is fixed on the Peltier element by paste or solder having a thermal conductivity of 30 W/mK or more.
